(19) United States
(12) Patent Application Publication
(10) Pub. No.: US 2011/0063861 A1
(43) Pub. Date: Mar. 17, 2011

(54) SYSTEM, METHOD, AND COMPUTER PROGRAM PRODUCT FOR ADJUSTING A HEADLIGHT ASSOCIATED WITH A VEHICLE, BASED ON A DISTANCE OF AN OBJECT FROM THE VEHICLE

(76) Inventors: Christopher M. Edgeworth, Longview, TX (US); Ronald A. Johnston, Longview, TX (US)

(21) Appl. No.: 12/881,525

(22) Filed: Sep. 14, 2010

Related U.S. Application Data
(60) Provisional application No. 61/241,990, filed on Sep. 14, 2009.

(51) Int. Cl. B60Q 1/08; B60Q 1/04

(52) U.S. Cl. 362/466; 362/464

(57) ABSTRACT

A system, method, and computer program product are provided for adjusting a headlight associated with a vehicle, based on a distance of an object from the vehicle. In operation, a signal is transmitted from a transmitter positioned on a vehicle. Further, a reflected signal is received from an object positioned in front of the vehicle. Additionally, a distance of the object from the vehicle is determined. Still yet, at least one headlight associated with the vehicle is adjusted based on the determined distance.

### FIELD OF THE INVENTION

The present invention relates to vehicles, and more particularly headlights associated with said vehicles.

### BACKGROUND

When a vehicle approaches the rear of another vehicle, usually at nighttime or other low ambient light conditions, the headlights of the approaching vehicle can cause a reflective glare from the bumper or other reflective objects of the vehicle or object being approached. This has the possibility of causing misjudgments of the location or exact position of the vehicle being approached. It can also cause a momentary disorientation or a discomfort of the operator of the approaching vehicle.

There is thus a need for addressing these and/or other issues associated with the prior art.

### SUMMARY

A system, method, and computer program product are provided for adjusting a headlight associated with a vehicle, based on a distance of an object from the vehicle. In operation, a signal is transmitted from a transmitter positioned on a vehicle. Further, a reflected signal is received from an object positioned in front of the vehicle. Additionally, a distance of the object from the vehicle is determined. Still yet, at least one headlight associated with the vehicle is adjusted based on the determined distance. Both the transmitted and received signals are controlled by a computer/processor and subsequent program to determine the parameters needed to make automatic adjustments to the approaching vehicle's headlights.

### BRIEF DESCRIPTION OF THE DRAWINGS

FIG. 1 shows the basic flow of the proposed system embodiment. A signal may be transmitted from a vehicle, the reflected signal from a secondary object may be received by a receiver located on the front of the vehicle, the distance between the two vehicles may be determined by a processing system, and an adjustment may be made to at least one of the associated headlights of the vehicle.

FIG. 2 shows a system for a transmitter and receiver in accordance with one general embodiment. The drawing illustrates the secondary object or vehicle, identifies the various elements within the primary vehicle, and the flow of the respective information and adjustment signals. These include the transmitted and reflected signals, the signals containing information for the distance processing and continuing system operation, and the information needed to adjust the headlights.

FIG. 3 shows a system for a radio frequency (RF) transmitter and receiver in accordance with one embodiment. The RF signal may be transmitted from the primary vehicle, reflected from the secondary object, received by the RF receiver, and processed to determine adjustment of the headlamps. In this embodiment, the headlights are adjusted by reducing the voltage and current to at least one headlight.

FIG. 4 shows an embodiment where a laser beam is used as the transmitted media. The reflected laser beam is received and used to determine the distance between the primary vehicle and secondary object. In this embodiment, the headlight adjustment is made by mechanically moving the light source horizontally or vertically. In another embodiment, the light reduction could be made by introducing filtering or deflectors to the headlight.

FIG. 5 illustrates an exemplary system in which the various architecture and/or functionality of the various previous embodiments may be implemented. This contains the processing and display functions necessary to induce the headlamp adjustment states.

### DETAILED DESCRIPTION

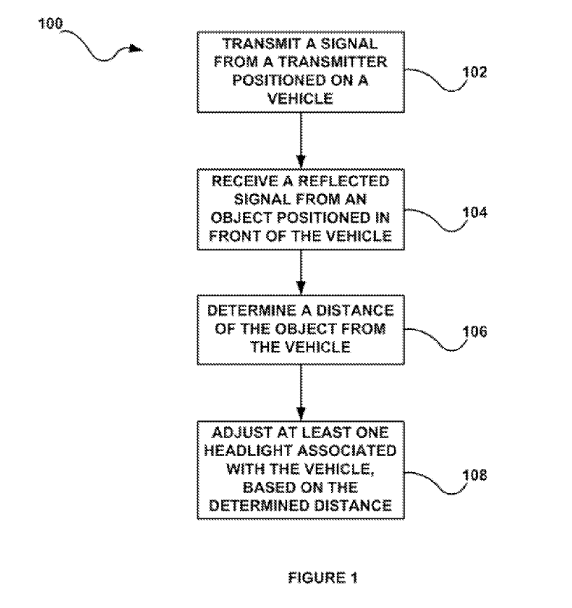

FIG. 1 shows a method 100 for adjusting a headlight associated with a vehicle, based on a distance of an object from the vehicle, in accordance with one embodiment. As shown, a signal is transmitted from a transmitter positioned on a vehicle. See operation 102.

In the context of the present description, a transmitter refers to any device capable of transferring a signal. For example, in various embodiments, the transmitter may include, but is not limited to, a radio signal transmitter, a light transmitter (e.g. a laser, an LED, etc.), a SONAR transmitter, and/or any other transmitter that meets the above definition.

Furthermore, the signal may include any type of signal. For example, in various embodiments, the signal may include a radio frequency (RF) signal, an optical signal, an acoustic signal (e.g. a sound wave, etc.), etc. In one embodiment, the transmitter may include a laser and an optical signal may be transmitted from a laser.

In another embodiment, the transmitter may include the headlight and the optical signal may be transmitted from the headlight. As an option, the transmitter may be positioned towards a front of the vehicle. For example, the transmitter may be positioned in a headlight assembly of the vehicle.

As another example, the transmitter may be positioned under the vehicle. As yet another option, the transmitter may be positioned on a roof of the vehicle. Still yet, the transmitter may be positioned on or near a dashboard of the vehicle. Of course, the transmitter may be placed at anywhere on the vehicle such that the signal may be transmitted.

As another example, the transmitter power source can be located in any appropriate location on the vehicle, with the antenna or other transmission means (e.g. light, laser, sound emitter) located where it can function most efficiently.

As shown further in FIG. 1, a reflected signal is received from an object positioned in front of the vehicle. See operation 104. The object may include any object.

For example, in one embodiment, the object may include another vehicle. In this case, the other vehicle may be a stopped vehicle (e.g. at a stop sign, a stop light, etc.). In another embodiment, the object may include a wall. In yet another embodiment, the object may include a parking structure (e.g. a parking column, etc.). Of course, the object may include any object capable of reflecting a signal.

Additionally, a distance of the object from the vehicle is determined. See operation 106. Still yet, at least one headlight associated with the vehicle is adjusted based on the determined distance. See operation 108.

The headlight may be adjusted in a variety of ways. For example, in one embodiment, adjusting the at least one headlight may include adjusting an intensity of light output from the at least one headlight. In another embodiment, adjusting an intensity of light output from the at least one headlight may include adjusting at least one of a current or voltage provided to a light source associated with the at least one headlight.

In yet another embodiment, adjusting the at least one headlight may include attenuating light output from the at least one headlight. As one option, this could be done by the insertion of filters into the headlamp. As another option, deflectors could be inserted or adjusted. As another option, adjusting the at least one headlight may include changing a pointing direction of light output from the at least one headlight. In this case, the pointing direction may be changed vertically and/or horizontally.

In any case, adjusting the at least one headlight may result in a decrease in the reflected light. The decrease in reflected light may include a decrease in reflected light seen by a driver of the vehicle.

It should be noted that it may also be determined if the measured distance between the object and the vehicle has changed. If it has, then at least one headlight may further be adjusted based on the change.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

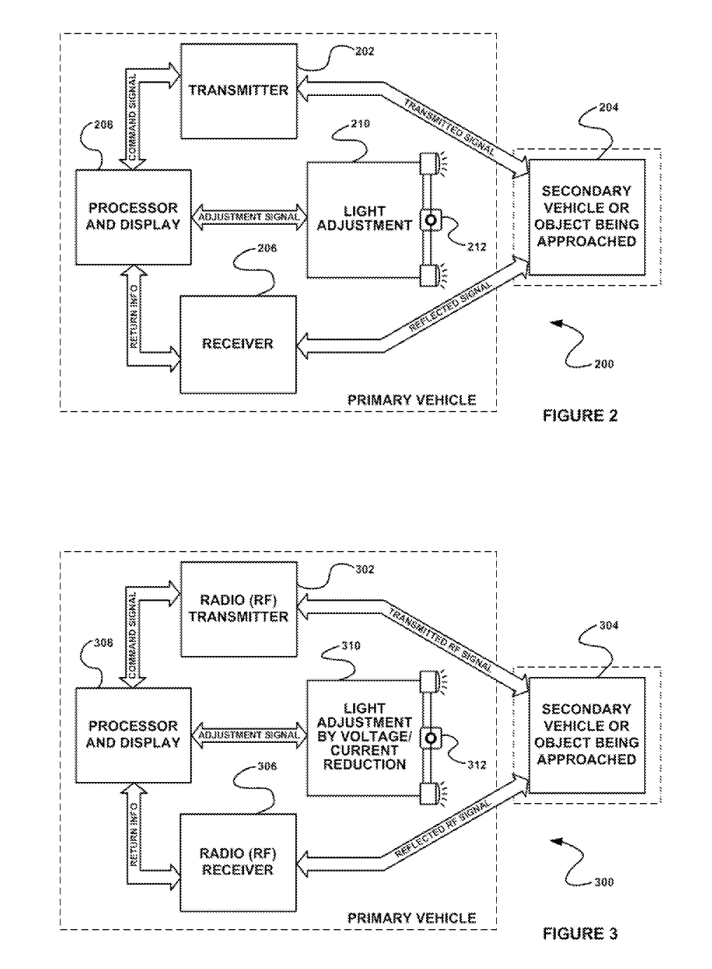

FIG. 2 shows a general system 200 for a transmitter and receiver in accordance with one embodiment. Transmitter 202 represents the device used to transmit a signal from the primary vehicle. It may contain the power source and transmittal device for the specified signal (ie. radio, sound, optical, laser, etc.). The power source and transmittal device (ie. antenna, light source, sound emitter, etc.) may be located separate from each other. The transmitter power source may be located in any convenient location of adequate size. The transmitting device may be an antenna, laser source, sound emitter, the headlight itself, etc., and may be located in such a position that a non-compromised view of the secondary object is available.

The secondary object 204 may be another vehicle. In another embodiment, the object may include a wall. In yet another embodiment, the object may include a parking structure (e.g. a parking column, etc.). Of course, the object may include any object capable of reflecting a signal specified signal being transmitted. The object or secondary vehicle 204 that is being approached may reflect the transmitted signal. The reflected or returned signal from the secondary vehicle may contain information relative to the distance between the primary vehicle and the object 206 and/or the speed of approach.

The receiver 206 receives the reflected signal and deciphers/formats it to a form of functional information that is usable by a processor 208. The transmitted, reflected, and received signal may be processed to determine the adjustment requirements. The processor 208 may contain the hardware and software program necessary to determine the distance between the primary vehicle and secondary object, the speed of approach, the requirements of further transmitted signals, and the information needed for adjusting the headlamps. The processor and associated equipment is described fully in FIG. 5. The command signal may trigger the transmitter 202 so continuous feedback information is present. The adjustment signal contains the information required by the adjustment device 210 that will be used to adjust the headlights 212. This embodiment is a generalized description that can be applied to several other embodiments utilizing various means of signals, transmissions, and headlight adjustment.

FIG. 3 shows a system for a radio transmitter and receiver in accordance with one embodiment. A radio frequency (RF) device 302 may be used to transmit a signal from the primary vehicle. It contains the power source and transmittal device required for generating the RF signal. The object or secondary vehicle 304 that is being approached reflects the generated RF signal. The radio receiver 306 may receive the reflected RF signal and format it into a scheme or pattern of useful information. Other transmission and receiving means are also possible. In one embodiment, an optical or laser beam could be the transmission device with a suitable receiver. In another embodiment, the transmitter could be a sound emitting (sonic) device with a suitable receiver. In yet another embodiment, the transmission device could be the existing headlamp with a suitable receiver receiving reflected information.

FIG. 3 also illustrates a method of decreasing light intensity by reducing the voltage and/or current to the headlight assembly 312. The light adjustment device 310 can take on a variety of prior art solutions. In one embodiment, pulse-width-modulation (PWM) may be used to reduce the voltage and/or current. In another embodiment, controlled power switching may be used. In yet another embodiment, increasing the resistance of the current path may be utilized. In all the embodiments, the processor 308 may be used to generate the proper commands and controls for the adjustments.

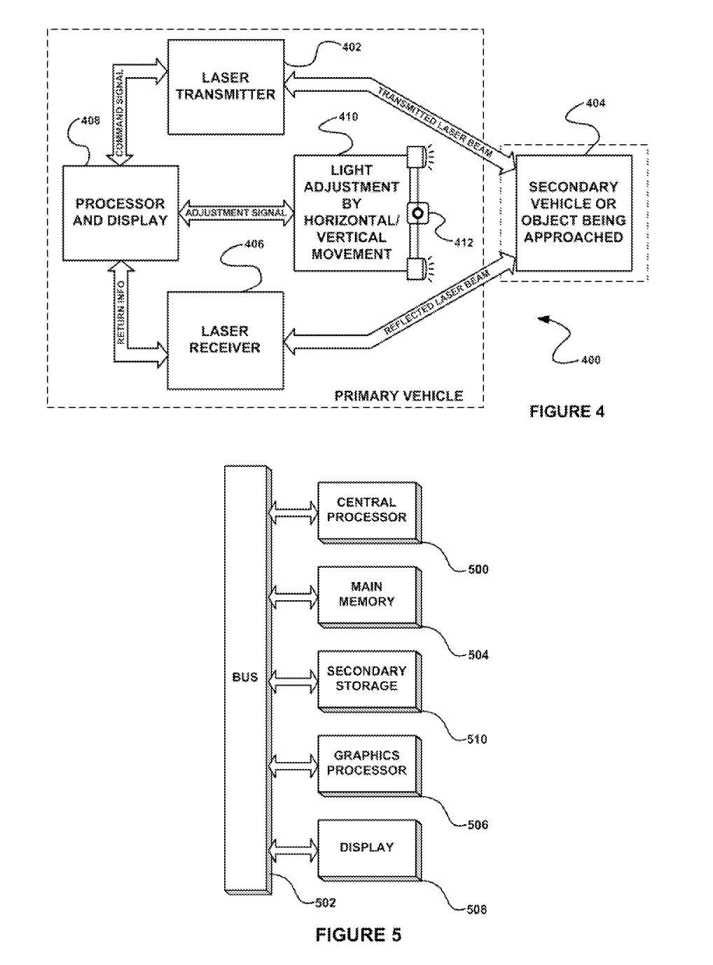

FIG. 4 shows a system for a Laser transmitter and receiver in accordance with one embodiment. A Laser device 402 may be used to transmit a laser beam from the primary vehicle. The object or secondary vehicle 404 that is being approached reflects the laser beam. The laser receiver 406 may receive the reflected laser beam and format it into a scheme or pattern of useful information. As previously noted, many other transmission and receiving means are also possible.

The processor 408 may be used to generate the proper commands and controls for the adjustment to the headlight 412. In this embodiment, the effective light intensity reduction may be accomplished by moving at least one headlight either vertically or horizontally by the adjustment device 410.

FIG. 5 illustrates an exemplary system in which the various architecture and/or functionality of the various previous embodiments may be implemented. As shown, a system is provided including at least one host processor 500 that is connected to a communication bus 502. The system also includes a main memory 504. Control logic (software) and data are stored in the main memory 504 which may take the form of random access memory (RAM).

The system also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system to perform various functions. Memory 504, storage 510 and/or any other storage are possible examples of computer-readable media.

In one embodiment, the architecture and/or functionality of the various previous figures may be implemented in the context of the host processor 500, graphics processor 506, an integrated circuit (not shown) that is capable of at least a portion of the capabilities of both the host processor 500 and the graphics processor 506, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system may take the form of a desktop computer, lap-top computer, and/or any other type of logic. Still yet, the system may take the form of various other devices including, but not limited to, a personal digital assistant (PDA) device, a mobile phone device, a television, etc.

Further, while not shown, the system may be coupled to a network [e.g. a telecommunications network, local area network (LAN), wireless network, wide area network (WAN) such as the Internet, peer-to-peer network, cable network, etc.] for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
transmitting a signal from a transmitter positioned on a vehicle;
receiving a reflected signal from an object positioned in front of the vehicle;
determining a distance of the object from the vehicle; and
adjusting at least one headlight associated with the vehicle, based on the determined distance.

2. The method of claim 1, wherein the signal is an optical signal.

3. The method of claim 2, wherein the transmitter includes a laser and the optical signal is transmitted from a laser.

4. The method of claim 2, wherein the transmitter includes the at least one headlight and the optical signal is transmitted from the headlight.

5. The method of claim 1, wherein the signal is a radio signal.

6. The method of claim 1, wherein the transmitter is positioned towards a front of the vehicle.

7. The method of claim 1, wherein the object includes another vehicle.

8. The method of claim 1, wherein adjusting the at least one headlight includes adjusting an intensity of light output from the at least one headlight.

9. The method of claim 8, wherein adjusting an intensity of light output from the at least one headlight includes adjusting at least one of a current or voltage provided to a light source associated with the at least one headlight.

10. The method of claim 1, wherein adjusting the at least one headlight includes attenuating light output from the at least one headlight.

11. The method of claim 1, wherein adjusting the at least one headlight includes changing a pointing direction of light output from the at least one headlight.

12. The method of claim 11, wherein the pointing direction is changed vertically.

13. The method of claim 11, wherein the pointing direction is changed horizontally.

14. The method of claim 1, wherein adjusting the at least one headlight includes inserting at least one filter.

15. The method of claim 14, wherein the at least one filter attenuates a total light spectrum associated with the at least one headlight.

16. The method of claim 14, wherein the at least one filter attenuates certain frequencies of a light spectrum associated with the at least one headlight.

17. The method of claim 1, wherein adjusting the at least one headlight includes inserting at least one deflector.

18. The method of claim 17, wherein the at least one deflector redirects a direction of the at least one headlight.

19. The method of claim 1, wherein adjusting the at least one headlight results in a decrease in the reflected light.

20. The method of claim 19, wherein the decrease in reflected light includes a decrease in reflected light seen by a driver of the vehicle.

21. The method of claim 1, further comprising determining if the determined distance has changed.

22. The method of claim 21, further comprising further adjusting the at least one headlight, based on the change.

23. The method of claim 1, wherein the object includes a stopped vehicle.

24. A computer program product embodied on a computer readable medium, comprising:
computer code for transmitting a signal from a transmitter positioned on a vehicle;
computer code for receiving a reflected signal from an object positioned in front of the vehicle;
computer code for determining a distance of the object from the vehicle; and
computer code for adjusting at least one headlight associated with the vehicle, based on the determined distance.

25. An apparatus, comprising:
a transmitter positioned on a vehicle for transmitting a signal;
a receiver for receiving a reflected signal from an object positioned in front of the vehicle;
a control module for determining a distance of the object from the vehicle; and
an adjustment mechanism for adjusting at least one headlight associated with the vehicle, based on the determined distance.
